(19) United States
(12) Patent Application Publication
(10) Pub. No.: US 2018/0299253 A1
(43) Pub. Date: Oct. 18, 2018

(54) LASER SCANNING METHOD AND APPARATUS FOR SEMICONDUCTOR DEVICE STAIRCASE STEP WIDTH MEASUREMENT

(71) Applicant: SANDISK TECHNOLOGIES LLC, Plano, TX (US)

(72) Inventors: Yutong LIU, San Jose, CA (US); Tomohiko NAKAMURA, Yokkaichi (JP)

(21) Appl. No.: 15/485,790

(22) Filed: Apr. 12, 2017

(51) Int. Cl. G01B 11/02; G01B 9/02

(52) U.S. Cl. CPC G01B 11/02; G01B 9/02012; G01B 9/0201

(57) ABSTRACT

A method of determining a width of a step in a stepped surface of a microstructure includes scanning an incident measurement laser beam across the stepped surface of the microstructure, detecting a reflected laser beam from the microstructure, and determining a width of the step in the stepped surface by at least one of detecting a consecutive pair of phase inflection points or consecutive pair of shifts in the detected reflected laser beam intensity.

### FIELD

The present disclosure relates generally to the field of semiconductor fabrication and specifically to a laser scanning measurement method and apparatus for measurement of dimension of steps in staircase in a semiconductor device.

### BACKGROUND

Destructive step dimension measurement on a stepped surface is disruptive and time-consuming. While atomic force microscopy (AFM) is available for non-destructive measurement of step dimensions, AFM measurement is sensitive to the tip condition, and physical contact between the tip of an AFM machine and a microstructure tends to introduce scratches, deform or distort soft materials on the microstruture, and/or introduce foreign materials as particulates onto the microstructure. Thus, a non-destructive non-contact measurement tool that can measure dimensions of steps on a microstructure is desired.

### SUMMARY

According to an aspect of the present disclosure, a method of determining a width of a step in a stepped surface of a microstructure includes scanning an incident measurement laser beam across the stepped surface of the microstructure, detecting a reflected laser beam from the microstructure, and determining a width of the step in the stepped surface by at least one of detecting a consecutive pair of phase inflection points or consecutive pair of shifts in the detected reflected laser beam intensity.

According to another aspect of the present disclosure, a laser interferometric dimension measurement tool for measurement of a dimension on a microstruture is provided, which comprises: a stage having a planar surface configured to mount an object thereupon; an optics assembly comprising a laser beam source configured to emit a laser emission beam and a first beam splitter configured to split the laser emission beam into an incident measurement laser beam that impinges on the object and a reference laser beam that travels along a different direction than the incident measurement laser beam, wherein the incident measurement laser beam generates a reflected measurement laser beam upon reflection from the object, wherein the optics assembly is configured to direct at least a fraction of the reflected measurement laser beam and at least a fraction of the reference laser beam to a photodetector; and a lateral actuation mechanism configured to provide relative lateral movement between the stage and the optics assembly. The laser interferometric dimension measurement tool is configured to induce an optical distance variation of a combination of the incident measurement laser beam and the reflected measurement laser beam by providing a relative movement between the object and the optics assembly while the incident measurement laser beam irradiates the object, and is further configured to calculate at least one dimension representing a feature on a surface of the object, employing a computational unit including a processor and a memory unit, based on interferometric intensity modulation that is detected at the photodetector while the optical distance variation is induced.

According to another aspect of the present disclosure, a laser scanning tool, comprises a stage having a top surface configured to mount an object thereupon, an optics assembly comprising a laser, a photodetector and at least one beam splitter or half mirror, and a lateral actuation mechanism configured to provide relative lateral movement between the stage and the optics assembly configured to scan an incident measurement laser beam from the laser across a stepped surface of a microstructure to be positioned on the stage. The photodetector is configured to detect a reflected laser beam from the microstructure and determine a width of a step in the stepped surface by at least one of detecting a consecutive pair of phase inflection points or consecutive pair of shifts in the detected reflected laser beam intensity.

### BRIEF DESCRIPTION OF THE DRAWINGS

FIG. 1 is a vertical cross-sectional view of an exemplary microstructure prior to formation of stepped surfaces on which a laser measurement of the present disclosure can be performed.

FIG. 2A is a top-down view of the exemplary microstructure after formation of stepped surfaces on which the laser measurement of the present disclosure can be performed. FIG. 2B is a vertical cross-sectional view of the exemplary microstructure of FIG. 2A.

FIG. 3A is a schematic side view illustration of the first exemplary laser dimension measurement tool of the present disclosure. FIG. 3B is a magnified vertical cross-sectional view of the exemplary microstructure while an incident measurement laser beam from a first exemplary laser dimension measurement tool irradiates stepped horizontal surfaces of the microstructure of FIG. 2 according to an embodiment of the present disclosure. FIG. 3C illustrates an exemplary phase shift measured at a phase detector photodetector during a relative horizontal movement between the optics assembly of the first exemplary laser dimension measurement tool and the substrate according to an embodiment of the present disclosure.

FIG. 4A is a vertical cross-sectional view of the exemplary microstructure while an incident measurement laser beam from a second exemplary laser interferometric dimension measurement tool irradiates a first horizontal surface of the exemplary microstructure of FIG. 2 according to an embodiment of the present disclosure. FIG. 4B is a vertical cross-sectional view of the exemplary microstructure while an incident measurement laser beam from the second exemplary laser interferometric dimension measurement tool irradiates a second horizontal surface of the exemplary microstructure of FIG. 2 according to an embodiment of the present disclosure.

FIG. 5A illustrates an exemplary interferometric intensity modulation as measured at a photodetector during a relative horizontal movement between the optics assembly of the second exemplary laser interferometric dimension measurement tool and the substrate according to an embodiment of the present disclosure.

FIG. 5B illustrates an exemplary interferometric intensity modulation as measured at a photodetector during relative vertical movements between the optics assembly of the second exemplary laser interferometric dimension measurement tool and the substrate at two different beam locations according to an embodiment of the present disclosure.

FIG. 6A illustrates a top-down view of the exemplary microstructure after formation of steps according to an embodiment of the present disclosure.

FIG. 6B illustrates a vertical cross-sectional view of the exemplary microstruture of FIG. 6A.

FIG. 7A illustrates a top-down view of the exemplary microstructure after formation of memory stack structures and contact via structures according to an embodiment of the present disclosure.

FIG. 7B illustrates a vertical cross-sectional view of the exemplary microstruture of FIG. 7A.

FIG. 7C is a magnified view of a memory opening including a memory stack structure of the exemplary microstructure of FIGS. 7A and 7B.

FIG. 8 is a vertical cross-sectional view of the exemplary microstructure while an incident measurement laser beam from a third exemplary laser interferometric dimension measurement tool irradiates a first horizontal surface of the exemplary microstructure of FIG. 2 according to an embodiment of the present disclosure.

FIG. 9 is a vertical cross-sectional view of the exemplary microstructure while an incident measurement laser beam from a third exemplary laser interferometric dimension measurement tool irradiates a second horizontal surface of the exemplary microstructure of FIG. 2 according to an embodiment of the present disclosure.

FIG. 10 is a vertical cross-sectional view of the exemplary microstructure while an incident measurement laser beam from a fourth exemplary laser interferometric dimension measurement tool irradiates a horizontal surface of the exemplary microstructure of FIG. 2 according to an embodiment of the present disclosure.

FIG. 11 is a vertical cross-sectional view of the exemplary microstructure while an incident measurement laser beam from a fifth exemplary laser interferometric dimension measurement tool irradiates a horizontal surface of the exemplary microstructure of FIG. 2 according to an embodiment of the present disclosure.

### DETAILED DESCRIPTION

As discussed above, the present disclosure is directed to a laser dimension measurement tool for measurement of a dimension on a microstructure, such as step width in a staircase in a semiconductor device, and methods of operating the same, the various aspects of which are described below. The drawings are not drawn to scale. Multiple instances of an element may be duplicated where a single instance of the element is illustrated, unless absence of duplication of elements is expressly described or clearly indicated otherwise. The same reference numerals refer to the same element or similar element. Unless otherwise indicated, elements having the same reference numerals are presumed to have the same composition and the same structural components.

Ordinals such as “first,” “second,” and “third” are employed merely to identify similar elements, and different ordinals may be employed across the specification and the claims of the instant disclosure. As used herein, a first element located “on” a second element can be located on the exterior side of a surface of the second element or on the interior side of the second element. As used herein, a first element is located “directly on” a second element if there exist a physical contact between a surface of the first element and a surface of the second element. As used herein, an “in-process” structure or a “transient” structure refers to a structure that is subsequently modified.

As used herein, a “layer” refers to a material portion including a region having a thickness. A layer may extend over the entirety of an underlying or overlying structure, or may have an extent less than the extent of an underlying or overlying structure. Further, a layer may be a region of a homogeneous or inhomogeneous continuous structure that has a thickness less than the thickness of the continuous structure. For example, a layer may be located between any pair of horizontal planes between, or at, a top surface and a bottom surface of the continuous structure. A layer may extend horizontally, vertically, and/or along a tapered surface. A substrate may be a layer, may include one or more layers therein, and/or may have one or more layer thereupon, thereabove, and/or therebelow.

As used herein, a “semiconducting material” refers to a material having electrical conductivity in the range from 1.0×10⁻⁶ S/cm to 1.0×10⁵ S/cm. As used herein, a “semiconductor material” refers to a material having electrical conductivity in the range from 1.0×10⁻⁶ S/cm to 1.0×10⁵ S/cm in the absence of electrical dopants therein, and is capable of producing a doped material having electrical conductivity in a range from 1.0 S/cm to 1.0×10⁵ S/cm upon suitable doping with an electrical dopant. As used herein, an “electrical dopant” refers to a p-type dopant that adds a hole to a valence band within a band structure, or an n-type dopant that adds an electron to a conduction band within a band structure. As used herein, a “conductive material” refers to a material having electrical conductivity greater than 1.0×10⁵ S/cm. As used herein, an “insulator material” or a “dielectric material” refers to a material having electrical conductivity less than 1.0×10⁻⁶ S/cm. As used herein, a “heavily doped semiconductor material” refers to a semiconductor material that is doped with electrical dopant at a sufficiently high atomic concentration to become a conductive material, i.e., to have electrical conductivity greater than 1.0×10⁵ S/cm. A “doped semiconductor material” may be a heavily doped semiconductor material, or may be a semiconductor material that includes electrical dopants (i.e., p-type dopants and/or n-type dopants) at a concentration that provides electrical conductivity in the range from 1.0×10⁻⁶ S/cm to 1.0×10⁵ S/cm. An “intrinsic semiconductor material” refers to a semiconductor material that is not doped with electrical dopants. Thus, a semiconductor material may be semiconducting or conductive, and may be an intrinsic semiconductor material or a doped semiconductor material. A doped semiconductor material can be semiconducting or conductive depending on the atomic concentration of electrical dopants therein. As used herein, a “metallic material” refers to a conductive material including at least one metallic element therein. All measurements for electrical conductivities are made at the standard condition.

A monolithic three dimensional memory array is one in which multiple memory levels are formed above a single substrate, such as a semiconductor wafer, with no intervening substrates. The term “monolithic” means that layers of each level of the array are directly deposited on the layers of each underlying level of the array. In contrast, two dimensional arrays may be formed separately and then packaged together to form a non-monolithic memory device. For example, non-monolithic stacked memories have been constructed by forming memory levels on separate substrates and vertically stacking the memory levels, as described in U.S. Pat. No. 5,915,167 titled “Three Dimensional Structure Memory.” The substrates may be thinned or removed from the memory levels before bonding, but as the memory levels are initially formed over separate substrates, such memories are not true monolithic three dimensional memory arrays. The substrate may include integrated circuits fabricated thereon, such as driver circuits for a memory device

The various three dimensional memory devices can include a monolithic three-dimensional NAND string memory device, and can be fabricated employing the various embodiments described herein. At least one memory cell in the first device level of the three dimensional array of NAND strings is located over another memory cell in the second device level of the three dimensional array of NAND strings.

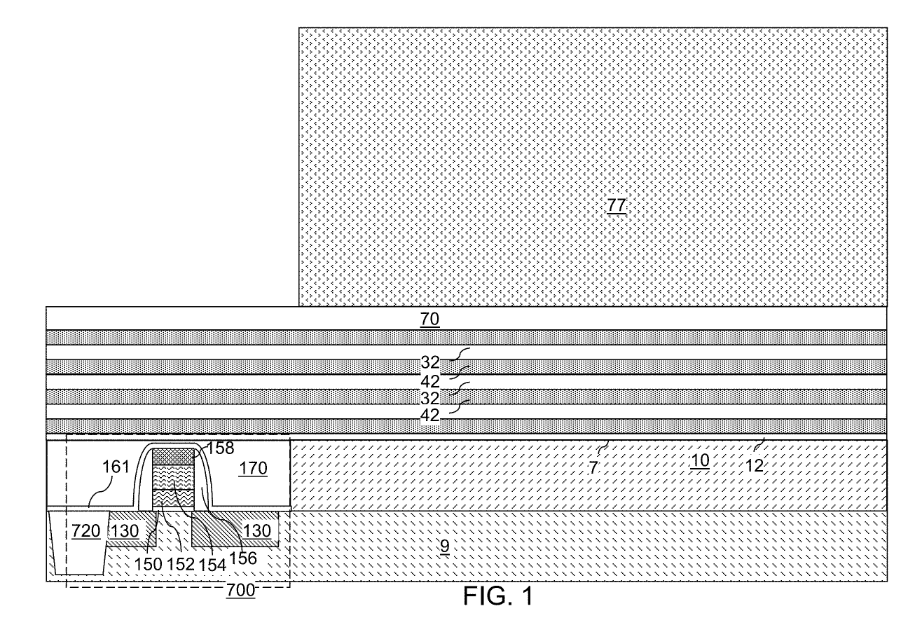

Referring to FIG. 1, an exemplary microstructure (e.g., a structure having step dimensions of 100 microns or smaller) is illustrated prior to formation of stepped surfaces on which laser measurement can be performed. The exemplary microstructure can be a semiconductor device, such as a vertical NAND memory device. The microstructure may also comprise other semiconductor or solid state devices. The exemplary microstructure includes a substrate (9, 10), which can be a semiconductor substrate. The substrate can include a substrate semiconductor layer 9 and an optional semiconductor material layer 10. The substrate semiconductor layer 9 maybe a semiconductor wafer or a semiconductor material layer, and can include at least one elemental semiconductor material (e.g., single crystal silicon wafer or layer), at least one III-V compound semiconductor material, at least one II-VI compound semiconductor material, at least one organic semiconductor material, or other semiconductor materials known in the art. The substrate can have a major surface 7, which can be, for example, a topmost surface of the substrate semiconductor layer 9. The major surface 7 can be a semiconductor surface. In one embodiment, the major surface 7 can be a single crystalline semiconductor surface, such as a single crystalline semiconductor surface.

At least one semiconductor device 700 for a peripheral circuitry can be formed on a portion of the substrate semiconductor layer 9. The at least one semiconductor device can include, for example, field effect transistors. For example, at least one shallow trench isolation structure 720 can be formed by etching portions of the substrate semiconductor layer 9 and depositing a dielectric material therein. A gate dielectric layer, at least one gate conductor layer, and a gate cap dielectric layer can be formed over the substrate semiconductor layer 9, and can be subsequently patterned to form at least one gate structure (150, 152, 154, 158), each of which can include a gate dielectric 150, a gate electrode (152, 154), and a gate cap dielectric 158. The gate electrode (152, 154) may include a stack of a first gate electrode portion 152 and a second gate electrode portion 154. At least one gate spacer 156 can be formed around the at least one gate structure (150, 152, 154, 158) by depositing and anisotropically etching a dielectric liner. Active regions 130 can be formed in upper portions of the substrate semiconductor layer 9, for example, by introducing electrical dopants employing the at least one gate structure (150, 152, 154, 158) as masking structures. Additional masks may be employed as needed. The active region 130 can include source regions and drain regions of field effect transistors. A dielectric liner 161 can be optionally formed. The dielectric liner 161 can comprise a silicon oxide layer, a silicon nitride layer, and/or a dielectric metal oxide layer. As used herein, silicon oxide includes silicon dioxide as well as non-stoichiometric silicon oxides having more or less than two oxygen atoms for each silicon atoms. The least one semiconductor device for the peripheral circuitry can contain a driver circuit for memory devices to be subsequently formed, which can include at least one NAND device.

A dielectric material such as silicon oxide can be deposited over the at least one semiconductor device, and can be subsequently planarized to form a planarization dielectric layer 170. In one embodiment the planarized top surface of the planarization dielectric layer 170 can be coplanar with a top surface of the dielectric liner 161. Subsequently, the planarization dielectric layer 170 and the dielectric liner 161 can be removed from an area to physically expose a top surface of the substrate semiconductor layer 9. As used herein, a surface is “physically exposed” if the surface is in physical contact with vacuum, or a gas phase material (such as air).

The optional semiconductor material layer 10, if present, can be formed on the top surface of the substrate semiconductor layer 9 prior to, or after, formation of the at least one semiconductor device 700 by deposition of a single crystalline semiconductor material, for example, by selective epitaxy. The deposited semiconductor material can be the same as, or can be different from, the semiconductor material of the substrate semiconductor layer 9. The deposited semiconductor material can be any material that can be employed for the semiconductor substrate layer 9 as described above. The single crystalline semiconductor material of the semiconductor material layer 10 can be in epitaxial alignment with the single crystalline structure of the substrate semiconductor layer 9. Portions of the deposited semiconductor material located above the top surface of the planarization dielectric layer 170 can be removed, for example, by chemical mechanical planarization (CMP). In this case, the semiconductor material layer 10 can have a top surface that is coplanar with the top surface of the planarization dielectric layer 170.

A stack of an alternating plurality of first material layers (which can be insulating layers 32) and second material layers (which can be sacrificial material layer 42) is formed over the top surface of the substrate, which can be, for example, on the top surface of the gate dielectric layer 12. As used herein, a “material layer” refers to a layer including a material throughout the entirety thereof. As used herein, an alternating plurality of first elements and second elements refers to a structure in which instances of the first elements and instances of the second elements alternate. Each instance of the first elements that is not an end element of the alternating plurality is adjoined by two instances of the second elements on both sides, and each instance of the second elements that is not an end element of the alternating plurality is adjoined by two instances of the first elements on both ends. The first elements may have the same thickness thereamongst, or may have different thicknesses. The second elements may have the same thickness thereamongst, or may have different thicknesses. The alternating plurality of first material layers and second material layers may begin with an instance of the first material layers or with an instance of the second material layers, and may end with an instance of the first material layers or with an instance of the second material layers. In one embodiment, an instance of the first elements and an instance of the second elements may form a unit that is repeated with periodicity within the alternating plurality.

Each first material layer includes a first material, and each second material layer includes a second material that is different from the first material. In one embodiment, each first material layer can be an insulating layer 32, and each second material layer can be a sacrificial material layer. In this case, the stack can include an alternating plurality of insulating layers 32 and sacrificial material layers 42, and can constitute a prototype stack of alternating layers comprising insulating layers 32 and sacrificial material layers 42. As used herein, a “prototype” structure or an “in-process” structure refers to a transient structure that is subsequently modified in the shape or composition of at least one component therein.

The stack of the alternating plurality is herein referred to as an alternating stack (32, 42). In one embodiment, the alternating stack (32, 42) can include insulating layers 32 composed of the first material, and sacrificial material layers 42 composed of a second material different from that of insulating layers 32. The first material of the insulating layers 32 can be at least one insulating material. As such, each insulating layer 32 can be an insulating material layer. Insulating materials that can be employed for the insulating layers 32 include, but are not limited to, silicon oxide (including doped or undoped silicate glass), silicon nitride, silicon oxynitride, organosilicate glass (OSG), spin-on dielectric materials, dielectric metal oxides that are commonly known as high dielectric constant (high-k) dielectric oxides (e.g., aluminum oxide, hafnium oxide, etc.) and silicates thereof, dielectric metal oxynitrides and silicates thereof, and organic insulating materials. In one embodiment, the first material of the insulating layers 32 can be silicon oxide.

In some embodiments, the second material of the sacrificial material layers 42 is a sacrificial material that can be removed selective to the first material of the insulating layers 32. As used herein, a removal of a first material is “selective to” a second material if the removal process removes the first material at a rate that is at least twice the rate of removal of the second material. The ratio of the rate of removal of the first material to the rate of removal of the second material is herein referred to as a “selectivity” of the removal process for the first material with respect to the second material.

The sacrificial material layers 42 may comprise an insulating material, a semiconductor material, or a conductive material. The second material of the sacrificial material layers 42 can be subsequently replaced with electrically conductive electrodes which can function, for example, as control gate electrodes of a vertical NAND device. Non-limiting examples of the second material include silicon nitride, an amorphous semiconductor material (such as amorphous silicon), and a polycrystalline semiconductor material (such as polysilicon). In one embodiment, the sacrificial material layers 42 can be spacer material layers that comprise silicon nitride or a semiconductor material including at least one of silicon and germanium.

In one embodiment, the insulating layers 32 can include silicon oxide, and sacrificial material layers can include silicon nitride sacrificial material layers. The first material of the insulating layers 32 can be deposited, for example, by chemical vapor deposition (CVD). For example, if silicon oxide is employed for the insulating layers 32, tetraethyl orthosilicate (TEOS) can be employed as the precursor material for the CVD process. The second material of the sacrificial material layers 42 can be formed, for example, CVD or atomic layer deposition (ALD).

The thicknesses of the insulating layers 32 and the sacrificial material layers 42 can be in a range from 20 nm to 50 nm, although lesser and greater thicknesses can be employed for each insulating layer 32 and for each sacrificial material layer 42. The number of repetitions of the pairs of an insulating layer 32 and a sacrificial material layer (e.g., a control gate electrode or a sacrificial material layer) 42 can be in a range from 2 to 1,024, and typically from 8 to 256, although a greater number of repetitions can also be employed. The top and bottom gate electrodes in the stack may function as the select gate electrodes. In one embodiment, each sacrificial material layer 42 in the alternating stack (32, 42) can have a uniform thickness that is substantially invariant within each respective sacrificial material layer 42.

Alternatively, the spacer material layers may be formed as electrically conductive layers instead of sacrificial material layers. In this case, subsequent replacement of the spacer material layers with electrically conductive layers is not necessary.

Optionally, an insulating cap layer 70 can be formed over the alternating stack (32, 42). The insulating cap layer 70 includes a dielectric material that is different from the material of the sacrificial material layers 42. In one embodiment, the insulating cap layer 70 can include a dielectric material that can be employed for the insulating layers 32 as described above. The insulating cap layer 70 can have a greater thickness than each of the insulating layers 32. The insulating cap layer 70 can be deposited, for example, by chemical vapor deposition. In one embodiment, the insulating cap layer 70 can be a silicon oxide layer.

A mask layer 77 can be formed over the insulating cap layer, and can be patterned to cover a memory array region in which a memory array is to be subsequently formed. An edge of the mask layer 77 can be located at a distal edge of a contact region in which stepped surfaces are to be subsequently formed. As used herein, a distal edge of the contact region refers to an edge of the contact region that is distal from the memory array region, and a proximal edge of the contact region refers to an edge of the contact region that is proximal to the memory array region. The mask layer 77 includes a material that can be isotropically trimmed, i.e., removed only at surface portions while not removing portions that are spaced from the physically exposed surfaces. In one embodiment, the mask layer 77 can include a photoresist material.

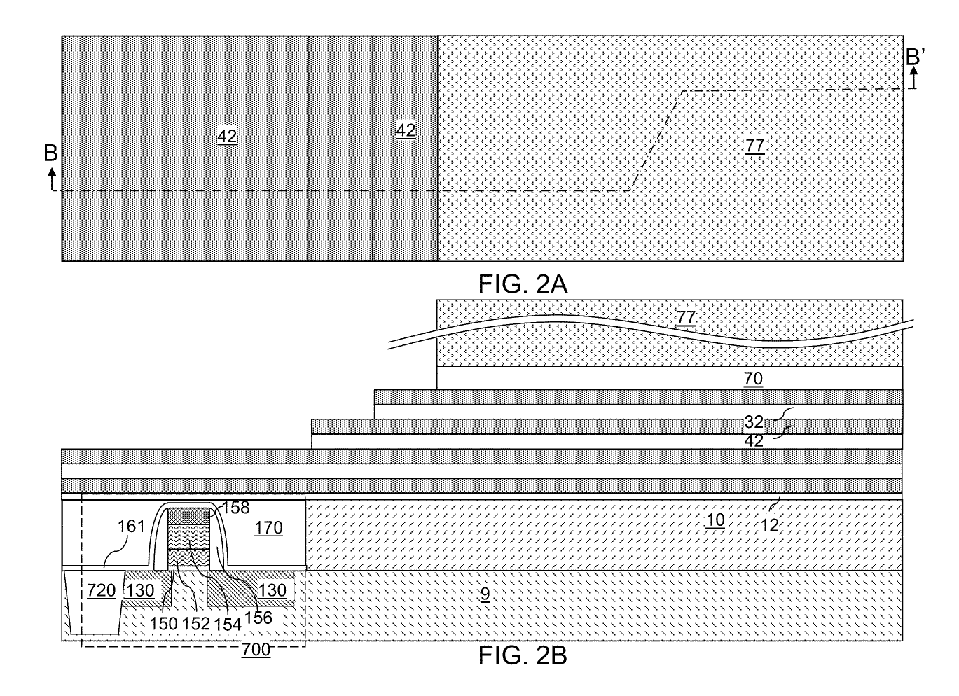

Referring to FIGS. 2A and 2B, an anisotropic etch process can be performed to etch physically exposed portions of the insulating cap layer 70. The chemistry of the anisotropic etch process can be selective to the material of the sacrificial material layers. A step is formed by a sidewall of the insulating cap layer 70 between the top surface of the insulating cap layer 70 and the physically exposed top surface of the topmost sacrificial material layer 42.

A combination of a trimming process and an anisotropic etch can be subsequently performed. For example, the mask layer 77 can be isotropically trimmed to shift the edge of the mask layer 77 toward the memory array region. Another anisotropic etch process can be performed, which includes a first step that etches the material of the physically exposed portions of the topmost sacrificial material layer 42 and a second step that etches the material of the insulating cap layer 70 and the topmost insulating layer 32. Stepped surfaces are formed that includes a sidewall of the insulating cap layer 70 (as laterally shifted from a location prior to the anisotropic etch process) and a pair of vertically coincident sidewalls of the topmost sacrificial material layer 42 and the topmost insulating layer 32 (which is formed at a location of the sidewall of the insulating cap layer prior to the anisotropic etch).

The combination of the trimming process and the anisotropic etch process can be repeated to form additional stepped surfaces. Each iteration of the combination of the trimming process and the anisotropic etch process increases the number of steps by one. Upon a second iteration of the combination of the trimming process and the anisotropic etch process, the microstructure illustrated in FIGS. 2A and 2B can be formed. The combination of the trimming process and the anisotropic etch process can be repeated as many times as necessary to form a staircase region in which stepped surfaces extend from the bottommost layer to the topmost layer of the alternating stack (32, 42).

The width of each step in the exemplary microstructure varies due to process variations during trimming of the making layer 77. Deviations of the actual lateral distance of the edge of the mask layer 77 from target locations, and thus deviations of the vertical steps of the stepped surfaces from target locations can be cumulative. In other words, positive or negative deviations from the ideal step width can be cumulative as additional stepped surfaces are formed with additional trimming of the masking layer as the combination of the trimming process and the anisotropic etch process is repeatedly performed. Thus, intermittent measurement of the step width during the iterations of the combination of the trimming process and the anisotropic etch process is desirable to perform corrective measures in case the horizontal step widths are below target or above target.

Destructive measurements such as scanning electron micrography (SEM) destroy the microstructure, and are very costly even if such measurements are performed to monitor wafers. While atomic force microscopy (AFM) is available for non-destructive measurement of step widths and/or step heights, such measurements do not provide high reliability and the measurement data is dependent on the conditions of the tip. Further, AFM measurements can be unsuitable for soft materials, can make scratches on the microstruture, and/or can introduce foreign materials (particulates) during operation as well being expensive to operate and maintain.

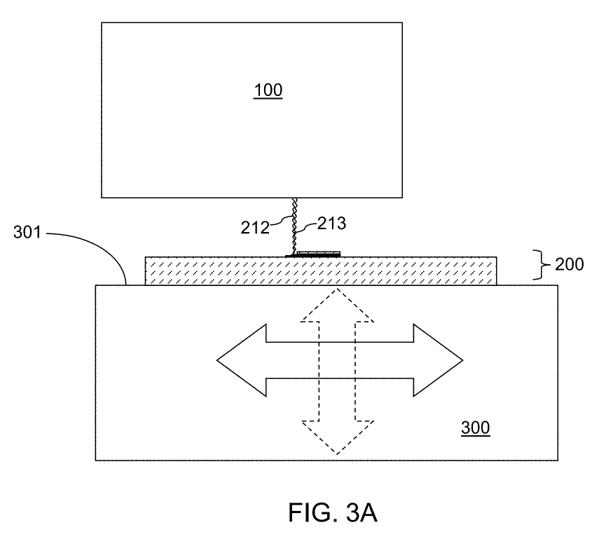

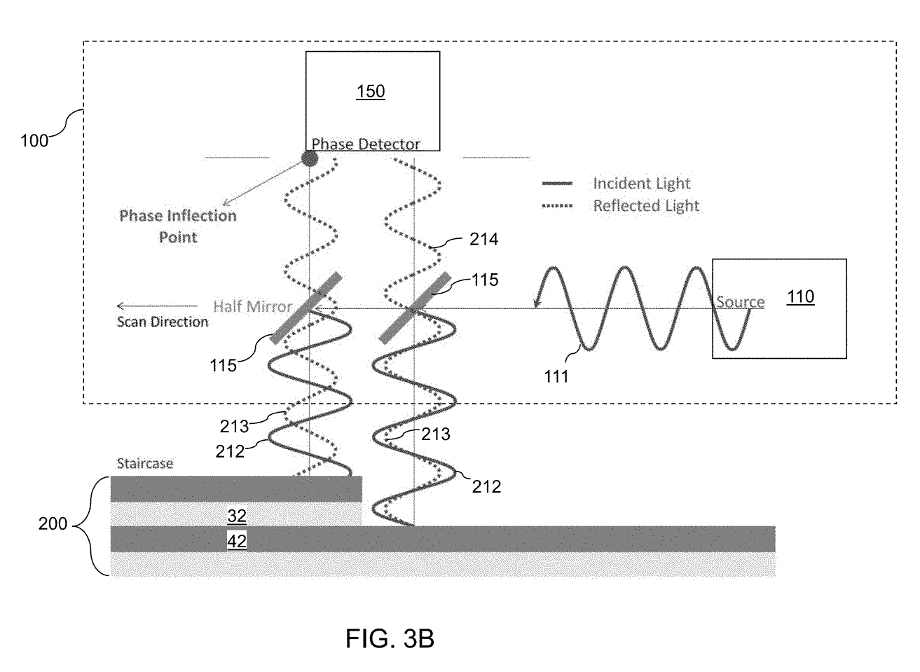

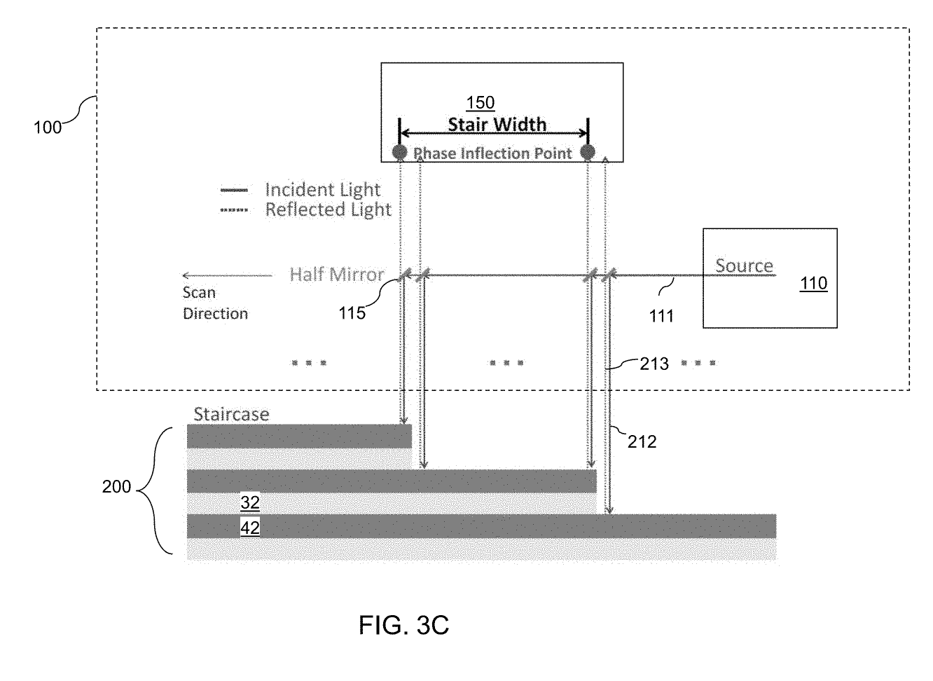

According to an aspect of the present disclosure and referring to FIGS. 3A and 3B, an apparatus for measuring step widths and/or step heights in microstructures such as the first exemplary microstructure of FIGS. 2A and 2B is provided. The apparatus can include a first exemplary laser dimension measurement tool illustrated in FIGS. 3A and 3B. FIG. 3A is an expanded view and FIG. 3B is a magnified view of the first exemplary laser dimension measurement tool.

As shown in FIG. 3A, the first exemplary laser dimension measurement tool for measurement of a dimension on a microstructure containing an optics assembly 100 and a stage 300 having a top surface 301 configured to mount an object (such as a microstructure 200 having a substrate 9) thereupon. As shown in FIG. 3B, the optics assembly 110 comprises a laser beam source (i.e., a laser) 110 configured to emit a laser emission beam 111, a half mirror 115 arranged at a 45 degree angle from the stage 300 surface and a phase detector photodetector 150. The half mirror 115 allows only light from a particular direction (e.g., reflected light from the microstructure 100 on the stage 300 to pass through and to reflect other light, such the laser emission beam 111). The half mirror 115 reflects the laser emission beam 111 onto an object (such as the microstructure 200) to generate an incident measurement laser beam 212. The incident measurement laser beam 212 generates a reflected measurement laser beam 213 upon reflection from the object. The reflected laser beam 213 is allowed to pass through the half mirror 115 to the phase detector photodetector 150. The phase detector photodetector 150 is configured to detect the phase of the received reflected laser beam 213. The phase of the reflected laser beam 213 will change as soon as the reflected laser beam 213 is reflected from a higher or lower step in the staircase in the microstructure 200 than before (i.e., the phase will change once the laser beam “climbs” up or down a step while scanning across the staircase). Thus, a phase inflection point is detected by the phase detector photodetector 150 at each step in the staircase.

FIG. 3C illustrates the mechanism of staircase step width measurement. The laser beam moves across the surface of the microstructure in a scanning direction, preferably at a constant speed. The width “w” of each step (i.e., stair) in the staircase can be calculated from the following formula: w=vΔt, where v is the speed of the laser beam being scanned across the microstructure and Δt is the time lag between two detected inflection points. In other words, the width of each step in the staircase is a product of the speed of the laser beam being scanned across the microstructure and the time between two detected inflection points (i.e., the time between the two inflection points in a consecutive pair inflection points).

Higher resolution can be achieved by narrowing the laser beam width and/or lowering the scanning speed. Higher throughput can be achieved by raising the scanning speed. The scanning speed can be selected based on a tradeoff between the desired resolution and throughput.

In one embodiment, the laser emission beam 111 can have a peak wavelength in a range from 150 nm to 800 nm, although lesser and greater wavelengths can also be employed for the laser emission beam. The maximum lateral dimension (such as the diameter in the case of a circular irradiated area) of an irradiated area of the incident measurement laser beam 212 at a surface of the object can be less than the maximum lateral dimension of steps for measuring step width. For example, the maximum lateral dimension of the irradiated area of the incident measurement laser beam 212 can be in a range from 50 nm to 2,000 nm.

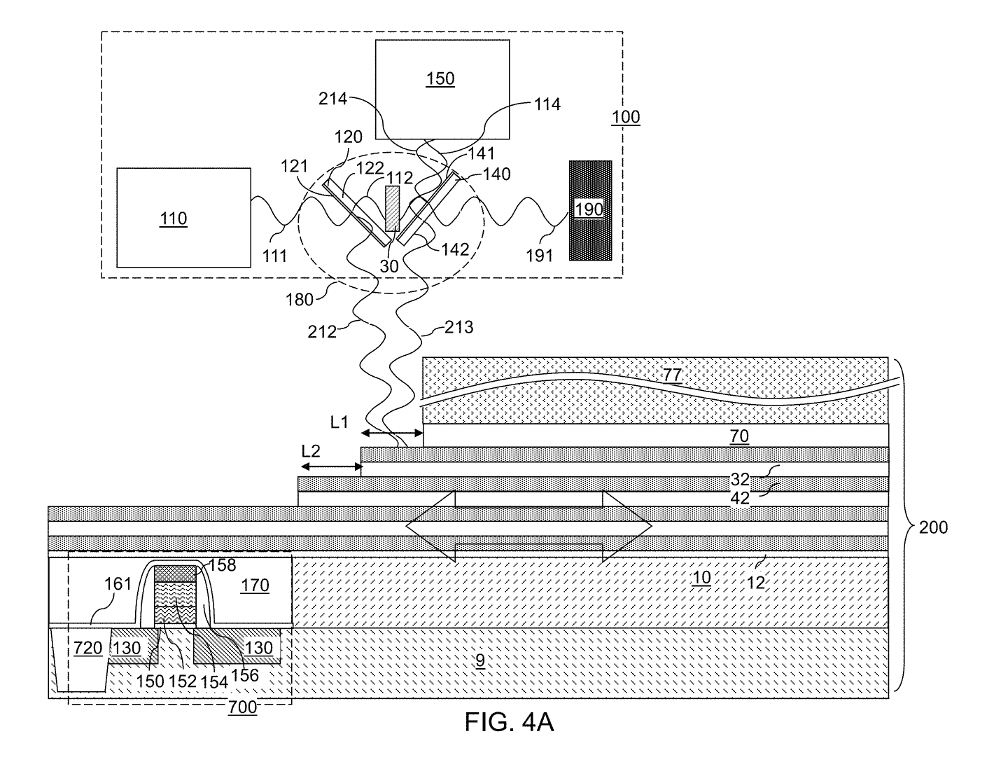

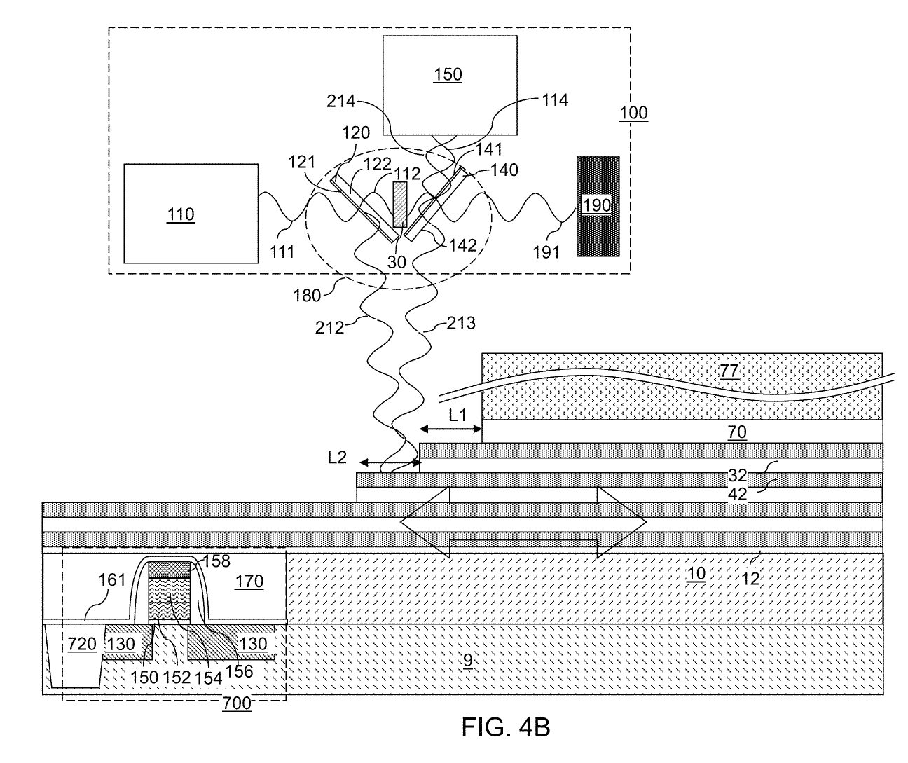

FIGS. 4A and 4B illustrate an apparatus according to a second embodiment of the present disclosure. The apparatus contains an optics assembly 100 and a stage 300 containing the microstructure 200 mounted thereon as in the first embodiment. The optics assembly 100 comprises a laser beam source (i.e., a laser) 110 configured to emit a laser emission beam 111 and an interferometer type photodetector 150. The optics assembly 100 also includes a first beam splitter 120 configured to split the laser emission beam 111 into an incident measurement laser beam 212 that impinges on the object (such as the microstructure 200) and a reference laser beam 112 that travels along a different direction than the incident measurement laser beam 212. The incident measurement laser beam 212 generates a reflected measurement laser beam 213 upon reflection from the object. The optics assembly 100 is configured to direct at least a fraction of the reflected measurement laser beam 213 and at least a fraction of the reference laser beam 112 to a photodetector 150.

Directing at least a fraction of the reflected measurement laser beam 213 and at least a fraction of the reference laser beam 112 to the photodetector 150 can be effected by a second beam splitter 140. The second beam splitter 140 can be configured to pass or reflect a fraction of the reference laser beam 112, thereby providing a first detection beam 114, and to reflect or pass the reflected measurement laser beam 213, thereby providing a second detection beam 214. In other words, the beam that is generated from the reference laser beam 112 by passing through, or by being reflected by, the second beam splitter 140 is the first detection beam 114; and the beam that is generated from the reflected measurement laser beam 213 by being reflected by, or by passing through, the second beam splitter 140 is the second detection beam 214. The first detection beam 114 and the second detection beam 214 impinge on the photodetector 150. One of the reference laser beam 112 and the reflected measurement laser beam 213 passes through the front surface 141, the body, and the back surface 142 of the second beam splitter 140, while the other of the reference laser beam 112 and the reflected measurement laser beam 213 is reflected off the front surface 141 of the second beam splitter 140.

In one embodiment, the laser emission beam 111 can have a peak wavelength in a range from 150 nm to 800 nm, although lesser and greater wavelengths can also be employed for the laser emission beam. The maximum lateral dimension (such as the diameter in the case of a circular irradiated area) of an irradiated area of the incident measurement laser beam 212 at a surface of the object can be less than the maximum lateral dimension of steps for measuring step width. For example, the maximum lateral dimension of the irradiated area of the incident measurement laser beam 212 can be in a range from 50 nm to 2,000 nm.

At least one intensity attenuator 30 may be optionally provided to attenuate one or more beams so that the interference of two beams impinging on the photodetector 150 can be maximized. The at least one intensity attenuator 30 may include one or more filters that partially absorb light at the wavelength of the laser beams. The first beam splitter 120, the second beam splitter 140, and the optional at least one intensity attenuator 30 are collectively referred to as an interferometric unit 180. Optionally, at least one beam absorber 190 can be provided to absorb at least one beam 191 that is not directed to the photodetector 150.

The laser beam source 110, the optics assembly 100, the photodetector 150 can be stationary among one another, i.e., can have a respective fixed position with respect to one another. In one embodiment, positions of the laser beam source 110. The interferometric unit 180 and the photodetector 150 can be stationary with respect to one another within the optics assembly 100.

A lateral actuation mechanism is provided in the stage 300 and/or in the optics assembly 100 to provide relative lateral movement between the stage 300 and the optics assembly 100. Thus, the stage 300 and the optics assembly 100 can move laterally with respect to each other. Optionally, the stage 300 and the optics assembly 100 can move vertically (i.e., closer and father apart) with respect to each other. FIG. 4A illustrates the first exemplary laser interferometric distance measurement tool while the incident laser measurement beam 212 illuminates a first horizontal surface during a lateral scan, and FIG. 4B illustrates the first exemplary laser interferometric distance measurement tool while the incident laser measurement beam 212 illuminates a second horizontal surface during the lateral scan.

In one embodiment, the stage 300 may be stationary with respect to the floor or other fixture (not shown) to which the laser interferometric dimension measurement tool is mounted, and the optics assembly 100 may move with respect to the floor or the fixture. In another embodiment, the optics assembly 100 may be stationary with respect to the floor or other fixture (not shown) to which the laser interferometric dimension measurement tool is mounted, and the stage 300 may move with respect to the floor or the fixture. Yet alternately, the optics assembly 100 and the stage 300 may independently move with respect to the floor or the fixture.

The laser interferometric dimension measurement tool is configured to induce an optical distance variation of a combination of the incident measurement laser beam 212 and the reflected measurement laser beam 213 by providing a relative movement between the object (such as the microstructure 200) and the optics assembly 100 while the incident measurement laser beam 212 irradiates the object.

In one embodiment, the optical distance variation can be provided by moving the optics assembly 100 with respect to the microstructure 200 along a direction substantially perpendicular to the direction of the incident measurement laser beam 212 by actuating the lateral actuation mechanism. As used herein, a first direction is “substantially perpendicular to” a second direction if the angle between the first direction and the second direction is in a range from 80 degrees to 100 degrees. For example, at least one of the optics assembly 100 and the microstructure 200 can move along the direction of the horizontal surfaces of the staircase region that includes a first horizontal surface having a first lateral dimension L1 and a second horizontal surface having a second lateral dimension L2. The first lateral dimension L1 can be the step width of the first horizontal surface (which is herein referred to as a first step width), and the second lateral dimension L2 can be a step width of the second horizontal surface (which is herein referred to as a second step width).

Various configurations for the first beam splitter 120 and the second beam splitter 140 can be employed within the optics assembly 100. In the configuration illustrated in FIG. 4A, the first beam splitter 120 provides the incident measurement laser beam 212 by reflecting a first fraction of the laser emission beam 111 off a front surface 121 of the first beam splitter 120. The first beam splitter 120 can provide the reference laser beam 112 by transmitting a second fraction of the laser emission beam 111 through the first beam splitter 120. Thus, the reference laser beam 112 includes the fraction of the laser emission beam 111 that passes through the front surface 121, the body, and the back surface 122 of the first beam splitter 120.

The optics assembly 100 can further comprise a second beam splitter 140 configured to pass a first one of the reference laser beam 112 and the reflected measurement laser beam 213, and to split a second one of the reference laser beam 112 and the reflected measurement laser beam 213. As discussed above, a beam is derived from the reference laser beam 112 by passing through, or by being reflected by, the second beam splitter, and is directed toward the photodetector 150 to form the first detection beam 114. Another beam is derived from the reflected measurement laser beam 213 by being reflected by, or by passing through, the second beam splitter 140, and is directed toward the photodetector 150 to form the second detection beam 214.

The first detection beam 114 and the second detection beam 214 impinge on the photodetector 150 to provide optical interference based on the difference in the two optical paths. One optical path includes the laser emission beam 111, the reference laser beam 112, and the first detection beam 114. The other optical path includes the laser emission beam 111, the incident measurement laser beam 212, the reflected measurement laser beam 213, and the second detection beam 214.

In the configuration of FIG. 4A, the first detection beam 114 is a continuation of the reference laser beam 112 that passes through the second beam splitter 140, and the second detection beam 214 is a fraction of the reflected measurement laser beam 213 that is reflected off the second beam splitter 140.

To operate the laser interferometric dimension measurement tool of the present disclosure, a microstructure 200 having a stepped front surface can be mounted to the top surface 301 (such as a planar top surface) of the stage 300. The incident measurement laser beam 212 can be directed to the stepped front surface of the microstructure 200. An optical distance variation of the combination of the incident measurement laser beam 212 and the reflected measurement laser beam 213 is induced by providing a relative movement between the microstructure 200 and the optics assembly 100 while the incident measurement laser beam 212 irradiates the stepped front surface. At least one dimension (such as the step width and/or the step height) representing a feature of the stepped front surface can be determined based on interferometric intensity modulation that is detected at the photodetector 150 while the optical distance variation is induced.

Optionally, at least one intensity attenuator 30 can be employed to maximize the intensity modulation due to the interference between the first and second detection beams (114, 214). In one embodiment, an intensity attenuator 30 may be located in a path of the reference laser beam 112 between the first beam splitter 120 and the second beam splitter 140 and can be configured to attenuate intensity of a portion of the reference laser beam 112 that impinges on the second beam splitter 140 for maximizing optical interference at the photodetector 150.

A relative movement between the optics assembly 100 and the microstructure 200 along the direction parallel to the top surface 301 of the stage 300, i.e., along a direction parallel to the horizontal surfaces of the microstructure 200, is herein referred to as a lateral movement. A relative movement between the optics assembly 100 and the microstructure 200 along the direction perpendicular to the top surface 301 of the stage 300, i.e., along a direction parallel to the horizontal surfaces of the microstructure 200, is herein referred to as a vertical movement.

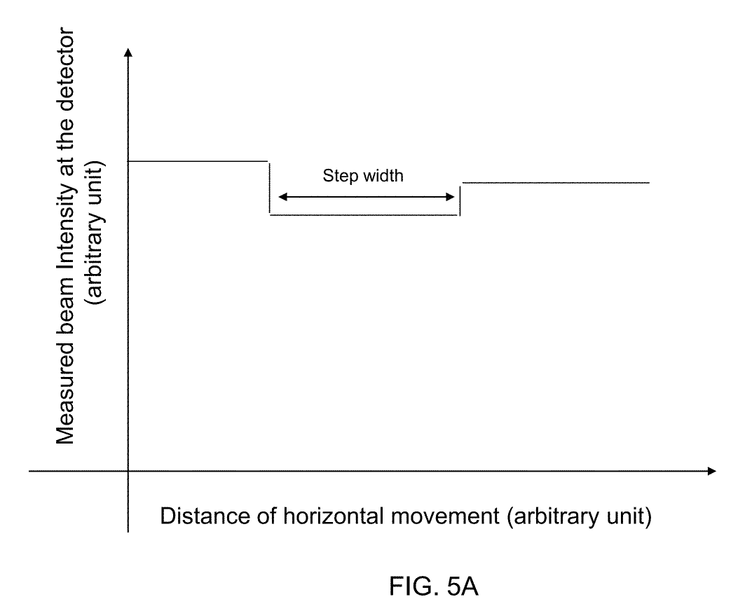

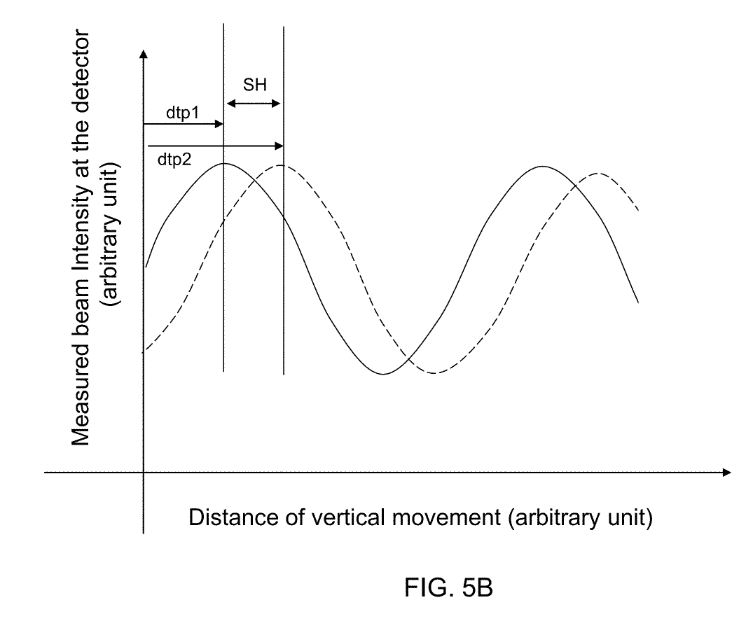

Referring to FIG. 5A, the optical distance of the combination of the incident measurement laser beam 212 and the reflected measurement laser beam 213 changes as the irradiation point of the incident measurement laser beam 212 moves across a vertical step of the top surface of the microstructure 200 during a relative lateral movement between the optics assembly 100 and the stage 300. For example, the irradiation point can move between the first horizontal surface having the first lateral dimension L1 and the second horizontal surface having the second lateral dimension L2 during the relative lateral movement between the optics assembly 100 and the stage 300. The change in the optical distance of the combination of the incident measurement laser beam 212 and the reflected measurement laser beam 213 alters the combined intensity (e.g., via constructive or destructive interference between the phases) of the two beams detected at the photodetector 150 (e.g., the interferometer photodetector), which detects the intensity of the interference of the first detection beam 114 and the second detection beam 214. In the illustrated case of FIGS. 4A and 4B, the phase of the second detection beam 214 changes as the optical length between the optics assembly 100 and the irradiation point (which is the reflection point) on the microstructure 200 changes during the scan at edges of each of the horizontal surfaces. The step width can be determined by measuring the distance of relative lateral movement between the optics assembly 100 and the stage 300 between consecutive changes in the measured beam intensity at the photodetector 150. In one embodiment, multiple lateral scans can be performed with different vertical distances between the optics assembly 100 and the microstructure 200 to enhance accuracy of detection at each vertical step of the stepped front surface of the microstructure 200.

While FIG. 5A illustrates an exemplary interferometric intensity modulation as measured at a photodetector 150 during a relative horizontal movement between the optics assembly of the first exemplary laser interferometric dimension measurement tool and the microstructure 200, the method illustrated in FIG. 5A can be employed for any laser interferometric dimension measurement tool of the present disclosure. Generally speaking, the step width of a horizontal surface of the stepped front surface that is laterally bounded by two sidewalls can be measured by determining a relative lateral movement distance between the optics assembly 100 and the stage 300 that causes a consecutive pair of shifts in a detected beam intensity at the photodetector 150 during a relative horizontal movement between the optics assembly 100 and the stage 300. The vertical distance can be maintained between the stage 300 and the optics assembly 100 can be maintained constant while the relative horizontal movement is provided.

Optionally, the laser interferometric dimension measurement tool can be provided with a vertical actuation mechanism for changing the physical distance between the optics assembly 100 and the stage 300. Referring to FIG. 5B, the vertical distance between the optics assembly and the irradiation point of the microstructure 200 can be changed by providing a relative vertical movement between the optics assembly 100 and the microstructure 200. During the relative vertical movement between the optics assembly 100 and the microstructure 200, the optical distance of the combination of the incident measurement laser beam 212 and the reflected measurement laser beam 213 changes while the incident measurement laser beam 212 irradiates a first irradiation point, which can be on the first horizontal surface having the first lateral dimension L1. The vertical distance can be changed until an extremum (a maximum or a minimum) in the measured intensity of the interference of the first and second detection beams (114, 214) is reached. The change in the vertical distance between the optics assembly 100 and the stage 300 for obtaining an extremum while the incident measurement laser beam 212 irradiates the first irradiation spot on the first horizontal plane is represented as a first distance to peak dtp1 in the illustrated example in FIG. 5B.

A lateral movement between the optics assembly 100 and the microstructure 200 can be subsequently provided so that the incident measurement laser beam 212 irradiates a second irradiation point on the second horizontal surface having the second lateral dimension L2. The vertical distance can be changed until a same type of extremum (a maximum or a minimum) is detected in the measured intensity of the interference of the first and second detection beams (114, 214). The change in the vertical distance between the optics assembly 100 and the stage 300 for obtaining an extremum while the incident measurement laser beam 212 irradiates the second irradiation spot on the second horizontal plane is represented as a second distance to peak dtp2 in the illustrated example in FIG. 5B.

While FIG. 5B illustrates an exemplary interferometric intensity modulation as measured at a photodetector 150 during relative vertical movements between the optics assembly 150 of the first exemplary laser interferometric dimension measurement tool and the microstructure 200 at two different beam locations, the method illustrated in FIG. 5B can be employed for any laser interferometric dimension measurement tool of the present disclosure. Generally speaking, the laser interferometric dimension measurement tool can include a vertical actuation mechanism configured to change a vertical separation distance between an object located on the stage 300 and the optics assembly 100 (for example, by changing the distance between the stage 300 and the optics assembly 100), and a computation unit provided with a fitting algorithm for detecting an incremental vertical separation distance (such as the first or second distance to peak (dtp1 or dtp2)) at which a detected beam intensity at the photodetector 150 reaches a local extremum while the incident measurement laser beam irradiates a fixed spot (such as the first irradiation point or the second irradiation point) on the object.

In one embodiment, the computation unit can be provided with another algorithm that calculates a difference between a pair of incremental vertical separation distances (such as the first and second distances to peak (dtp1, dtp2)) that provide respective local extrema in the detected beam intensity at two laterally separated points (such as the first irradiation point and the second irradiation point) on the object, and to provide a step height between the two laterally separated points by calculating the difference between the pair of incremental vertical separation distances. For example, the vertical distance between the microstructure 200 and the optics assembly 100 can be changed while the incident measurement laser beam 212 irradiates a first horizontal surface of the stepped front surface to determine a first incremental vertical separation distance (such as the first distance to peak dtp1) at which a detected beam intensity at the photodetector 150 reaches a first local extremum. Then, the incident measurement laser beam 212 can be directed to a second horizontal surface of the stepped front surface through a relative lateral movement between the optics assembly 100 and the microstructure 200. The vertical distance between the front horizontal surface and the optics assembly can be changed while the incident measurement laser beam irradiates a second horizontal surface of the stepped front surface to determine a second incremental vertical separation distance (such as the second distance to peak dtp2) at which the detected beam intensity at the photodetector 150 reaches a second local extremum. A step height between the first horizontal surface and the second horizontal surface can be determined by calculating a difference between the second incremental vertical separation distance and the first incremental vertical separation distance.

In case the general direction of the steps in the staircase region is known (for example, regions proximal to the memory array region can be generally higher (i.e., closer to the optics assembly 100) than regions distal from the memory array region), and if the physical step height is less than half of the wavelength of the laser beam, the step height can be the same as the vertical distance that the optics assembly 100 moves relative to the microstructure 200. In the illustrated example, the step height SH between the first horizontal plane and the second horizontal plane can be calculated by subtracting the first distance to peak dtp1 from the second distance to peak dtp2. Thus, the height of the steps can also be measured in addition to the width of the steps on the microstructure 200.

In one embodiment, a maximum lateral dimension of an irradiated area of the incident measurement laser beam can be less than a minimum lateral dimensions of two neighboring horizontal surfaces of the stepped front surface that are adjoined by a vertical surface. The laser emission beam can have a wavelength that is less than one half of a height of the vertical surface.

Generally speaking, the laser interferometric dimension measurement tool can be configured to calculate at least one dimension representing a feature on a surface of the object (such as the microstructure 200), employing a computational unit including a processor and a memory unit, based on interferometric intensity modulation that is detected at the photodetector while the optical distance variation is induced. As discussed above, the optical distance variation can be induced by providing a relative lateral movement so that the irradiation point of the beam on the microstructure 200 moves over a vertical step, or can be induced by changing a vertical distance between the optics assembly 100 and the microstructure 200.

In one embodiment, the laser interferometric dimension measurement tool is configured to measure a step width of a horizontal surface located between two sidewalls and on a front surface of the object by determining a relative lateral movement distance between the optics assembly and the stage that causes a consecutive pair of shifts in a detected beam intensity at the photodetector 150 during a relative horizontal movement between the optics assembly and the stage.

In one embodiment, the laser interferometric dimension measurement tool can be configured to maintain a same vertical distance between the stage 300 and the optics assembly 100 constant while the relative horizontal movement is provided. In this case, the optical distance of the combination of the of the incident measurement laser beam 212 and the reflected measurement laser beam 213 changes by twice the step height when the irradiation point moves over a vertical step on the front side of the microstructure 200.

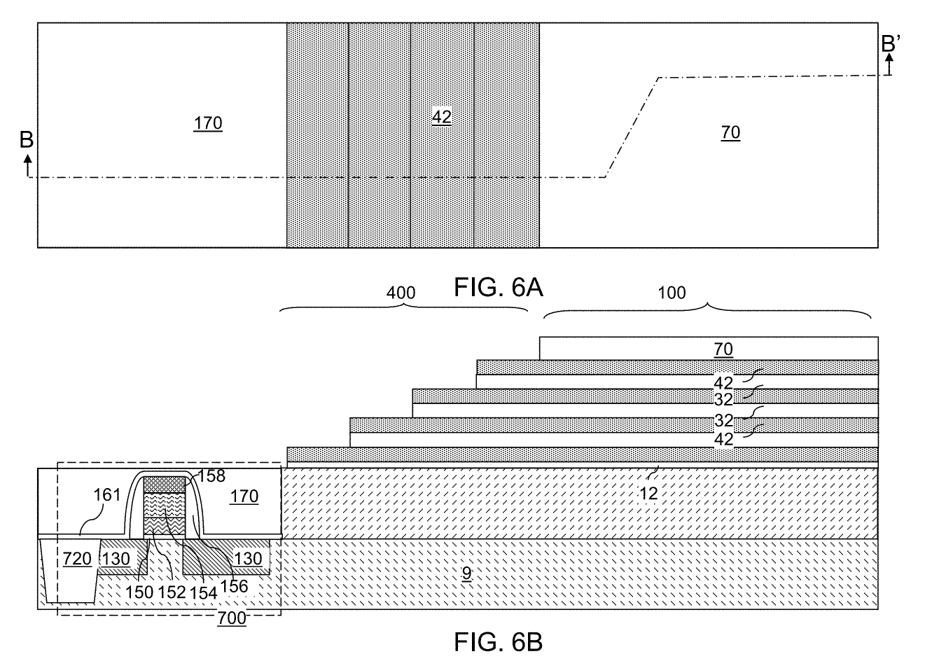

The laser interferometric dimension measurement tool of the present disclosure can be employed to control the trimming process for the masking layer 77 during the trimming process. If the horizontal steps are narrower than the target widths after forming a subset of horizontal steps, the duration or the intensity of the trimming process can be increased during subsequent trimming steps that form additional horizontal steps during the multiple iterations of the trimming process and the anisotropic etch process. If the horizontal steps are wider than the target widths after forming a subset of horizontal steps, the duration or the intensity of the trimming process can be decreased during subsequent trimming steps that form additional horizontal steps during the multiple iterations of the trimming process and the anisotropic etch process. Thus, deviations from the target widths for the horizontal steps can be corrected during formation of a staircase structure that extend from the topmost layer of the alternating stack (32, 42) to the bottommost layer of the alternating stack (32, 42). FIGS. 6A and 6B illustrate the exemplary microstruture after formation of the staircase structure in a contact region 400, which is formed adjacent to a memory array region 100.

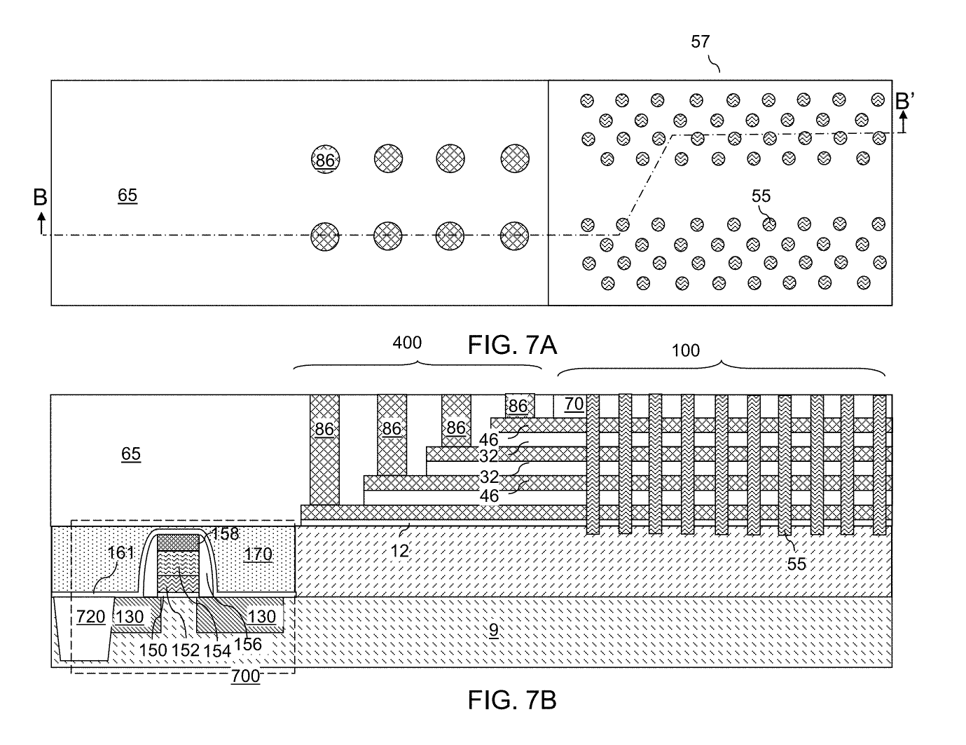

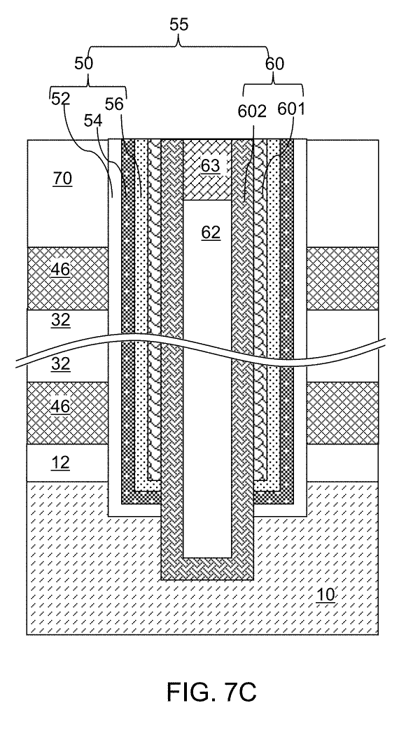

Referring to FIGS. 7A-7C, memory stack structures 55 can be formed in the memory array region, for example, by forming memory openings extending through the alternating stack (32, 42), and by depositing a memory film 50 within each of the memory openings. The memory film 50 can include, from outside to inside within each memory opening, a blocking dielectric layer 52, a charge storage layer 54, and a tunneling dielectric layer 56. The memory film 50 can be subsequently anisotropically etched to form openings at the bottom of each memory opening, and a vertical semiconductor channel 60 can be deposited on each tunneling dielectric layer 56 to provide a memory stack structure 55 including a respective memory film 50 and a respective vertical semiconductor channel 60 within each memory opening. Each vertical semiconductor channel 60 may include a single semiconductor layer or a lateral stack of an outer semiconductor layer 601 and an inner semiconductor layer 602. Optionally, a dielectric core 62 can be formed within each memory opening. A drain region 63 can be formed at the top of each vertical semiconductor channel 60. A source region (not shown) can be formed at a surface of the semiconductor material layer 10. A semiconductor channel between a source region and each drain region 63 can include a horizontal semiconductor channel that is a surface portion of the semiconductor material layer and a respective vertical semiconductor channel 60. The sacrificial material layers 42 can be replaced with electrically conductive layers 46 (e.g., word lines/control gates and select gates of the vertical NAND device), and contact via structures 86 can be formed on the stepped surfaces of the electrically conductive layers 46 in the contact region 200.

While a particular three-dimensional memory device is employed as an example of a microstruture, the measurement methods of the present disclosure can be employed in any microstructure or even on macroscopic structures to measure step height variations that is less than, or on the order of, the wavelength of the laser beam. In one embodiment, an infrared wavelength can be employed for the laser beam to enable measurement of step heights up to about 10 microns. The upper limit to the measurable step width is determined by the extent of lateral movement between the optics assembly 100 and the stage 300, and may be in a range from 10 cm to 1 m, although greater step widths can also be measured by enabling a greater lateral movement distance between the optics assembly 100 and the stage 300. The lower limit to the measurable step width is determined by the effective lateral dimension of the beam along the direction of the measurement, i.e., along the direction of the lateral movement between the optics assembly 100 and the stage 300. For example, in case the incident measurement laser beam 212 has a circular beam area, the lower limit to the measurable step width can be on the order of the diameter of the beam. The lower limit to the measurable step width can be decreased by employing additional optical components such as a lens or lens system (not expressly shown) that focuses the incident measurement laser beam 212 to a smaller area and incorporated into the optics assembly 100.

Various configurations can be employed for the laser interferometric dimension measurement tool of the present disclosure.

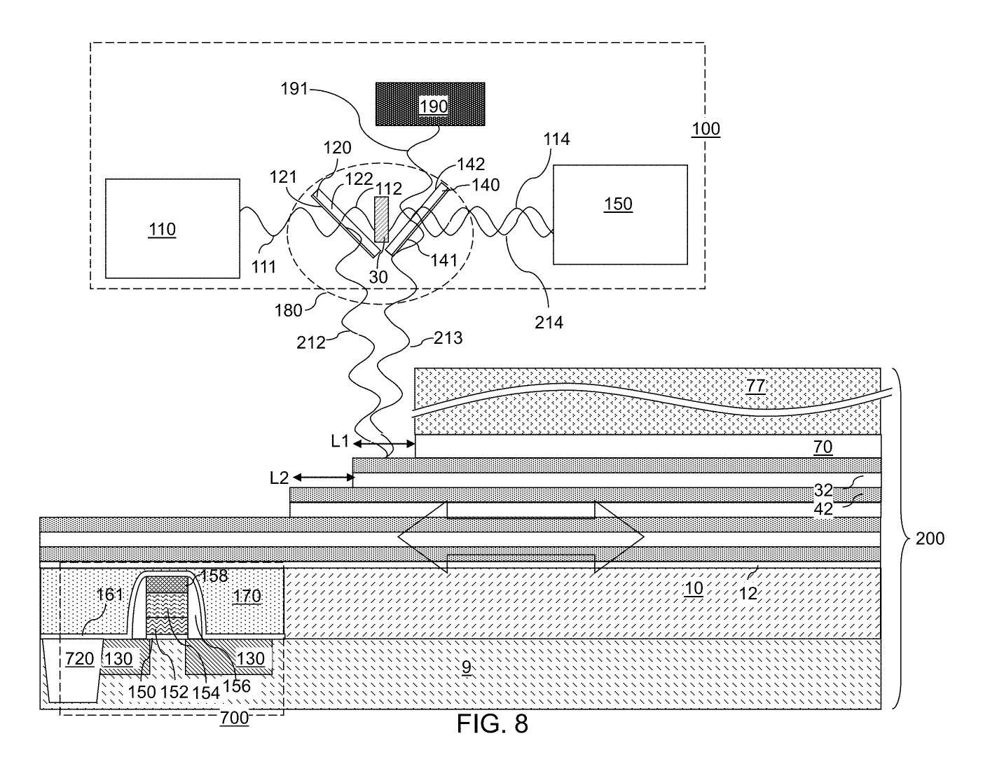

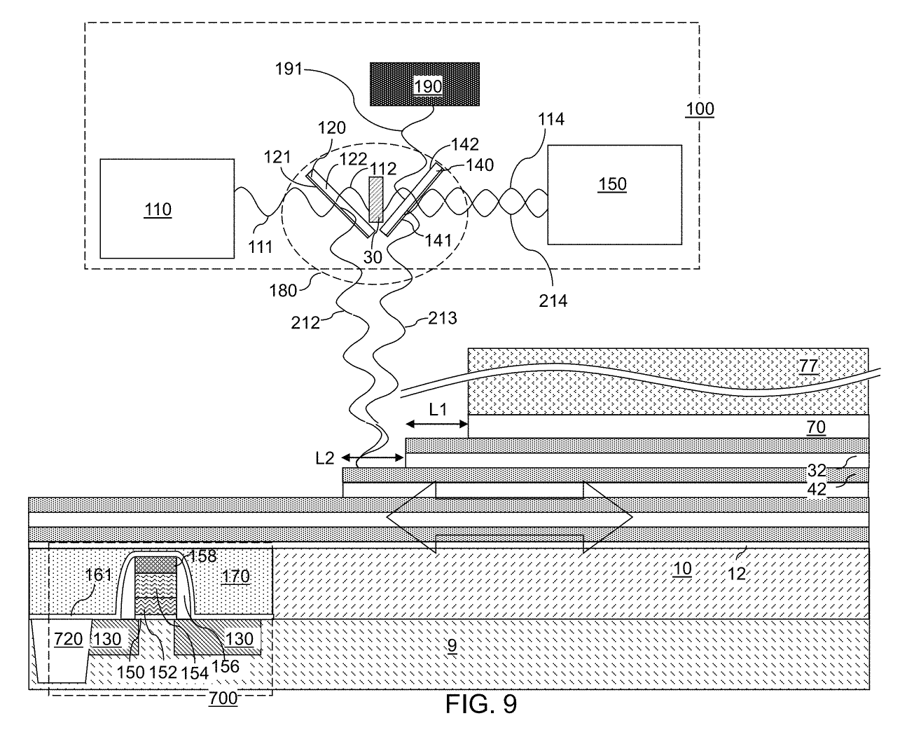

FIG. 8 illustrates a third exemplary laser interferometric distance measurement tool while the incident laser measurement beam 212 illuminates a first horizontal surface during a lateral scan, and FIG. 9 illustrates the first exemplary laser interferometric distance measurement tool while the incident laser measurement beam 212 illuminates a second horizontal surface during the lateral scan. A first beam splitter 120 is configured to split the laser emission beam 111 into an incident measurement laser beam 212 that impinges on the object (such as the microstructure 200) and a reference laser beam 112 that travels along a different direction than the incident measurement laser beam 212. Specifically, a fraction of the laser emission beam 111 that passes through the front surface 121, the body, and the back surface 122 of the first beam splitter 120 constitutes the reference laser beam 112, and the fraction of the laser emission beam that is reflected off the front surface 121 of the first beam splitter 120 constitutes the incident measurement laser beam 212. The incident measurement laser beam 212 generates a reflected measurement laser beam 213 upon reflection from the object. The optics assembly 100 is configured to direct at least a fraction of the reflected measurement laser beam 213 and at least a fraction of the reference laser beam 112 to a photodetector 150. The first detection beam 114 is a continuation of the reference laser beam 212 that passes through the second beam splitter 140. The second detection beam 214 is a fraction of the reflected measurement laser beam 213 that is reflected off the second beam splitter 140.

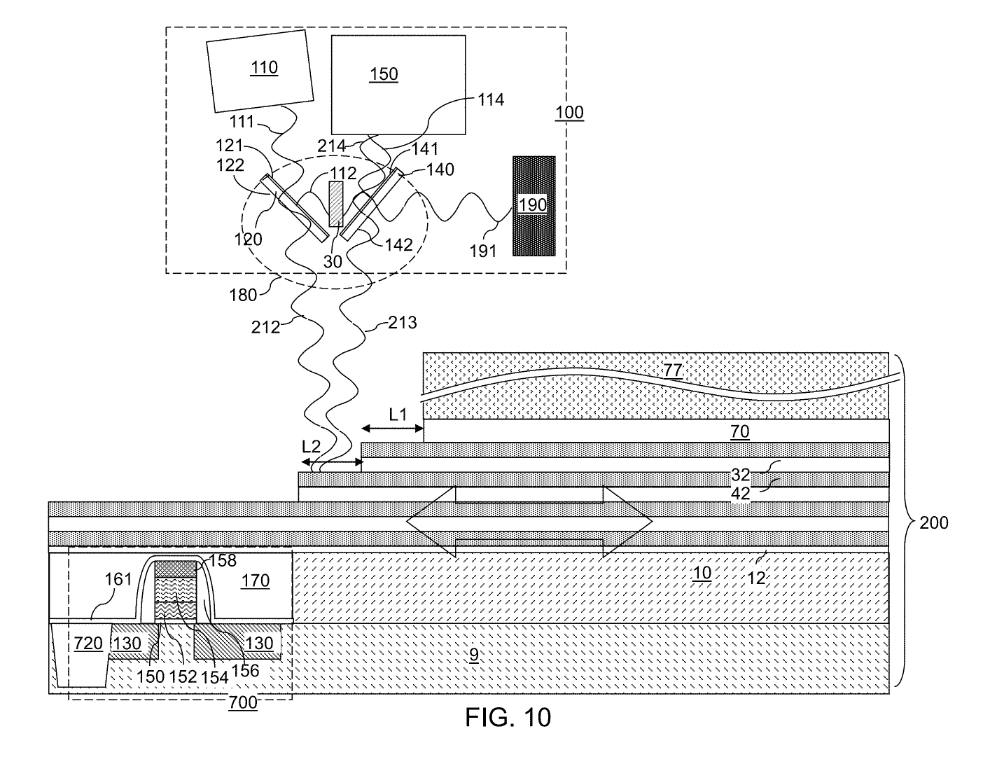

FIG. 10 illustrates a fourth exemplary laser interferometric dimension measurement tool. A first beam splitter 120 is configured to split the laser emission beam 111 into an incident measurement laser beam 212 that impinges on the object (such as the microstructure 200) and a reference laser beam 112 that travels along a different direction than the incident measurement laser beam 212. In this case, the first beam splitter 120 provides the incident measurement laser beam 212 by transmitting a first fraction of the laser emission beam 111 through the first beam splitter 120, and the first beam splitter provides the reference laser beam 112 by reflecting a second fraction of the laser emission beam 111 off a front surface 121 of the first beam splitter 120. In other words, a fraction of the laser emission beam 111 that is reflected off the front surface 121 of the first beam splitter 120 constitutes the reference laser beam 112, and the fraction of the laser emission beam that passes through the front surface 121, the body, and the back surface 122 of the first beam splitter 120 constitutes the incident measurement laser beam 212.

The incident measurement laser beam 212 generates a reflected measurement laser beam 213 upon reflection from the object. The optics assembly 100 is configured to direct at least a fraction of the reflected measurement laser beam 213 and at least a fraction of the reference laser beam 112 to a photodetector 150. The first detection beam is a fraction of the reference laser beam 112 that is reflected off the front surface 141 of the second beam splitter 140, and the second detection beam 214 is a fraction of the reflected measurement laser beam 213 that passes through the front surface 141, the body, and the back surface 142 of the second beam splitter 140.

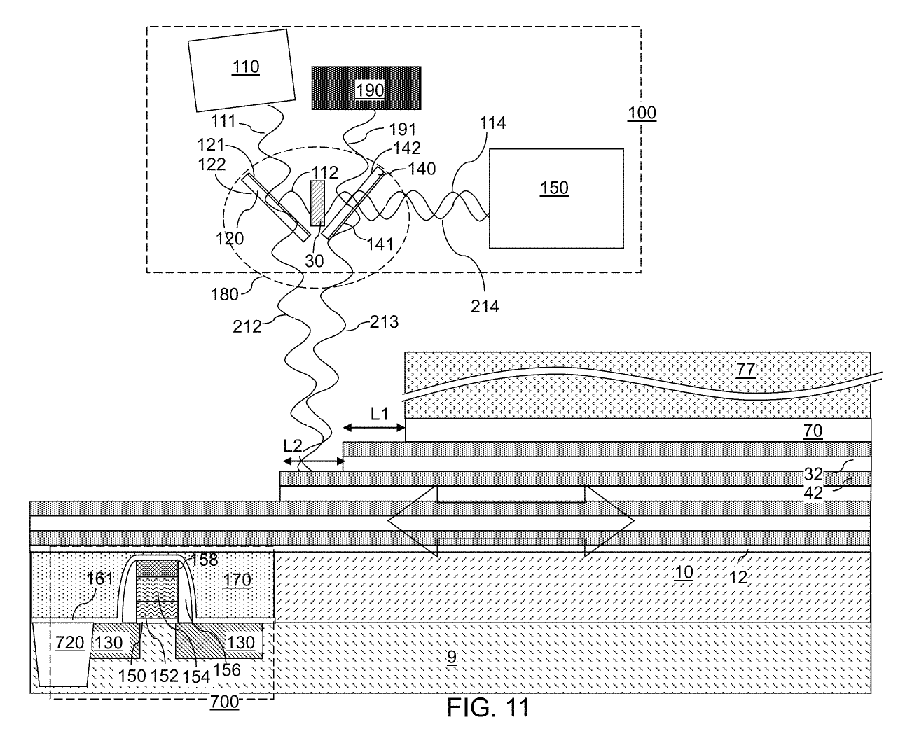

FIG. 11 illustrates a fifth exemplary laser interferometric dimension measurement tool. A first beam splitter 120 is configured to split the laser emission beam 111 into an incident measurement laser beam 212 that impinges on the object (such as the microstructure 200) and a reference laser beam 112 that travels along a different direction than the incident measurement laser beam 212. The first beam splitter 120 provides the incident measurement laser beam 212 by transmitting a first fraction of the laser emission beam 111 through the first beam splitter 120, and the first beam splitter provides the reference laser beam 112 by reflecting a second fraction of the laser emission beam 111 off a front surface 121 of the first beam splitter 120.

The incident measurement laser beam 212 generates a reflected measurement laser beam 213 upon reflection from the object. The optics assembly 100 is configured to direct at least a fraction of the reflected measurement laser beam 213 and at least a fraction of the reference laser beam 112 to a photodetector 150. The first detection beam is a fraction of the reference laser beam 112 that passes through the front surface 141, the body, and the back surface 142 of the second beam splitter 140, and the second detection beam 214 is a fraction of the reflected measurement laser beam 213 that is reflected off the front surface 141 of the second beam splitter 140.

The various embodiments of the present disclosure provide a non-destructive step dimension measurement method that can be employed during fabrication of structures, such as semiconductor devices, to measure dimensions of stepped surfaces without physical contact, thereby preventing structural distortion or contamination of the microstructure during the fabrication process.

For example, a method of determining a width of a step in the stepped surface of a microstructure includes scanning an incident measurement laser beam 212 across the stepped surface of the microstructure 200, detecting a reflected laser beam (213 and/or 214) from the microstructure, and determining a width of the step in the stepped surface by at least one of detecting a consecutive pair of phase inflection points, described above with respect to the first embodiment in FIGS. 3A-3C, or detecting a consecutive pair of shifts in the detected reflected laser beam intensity, as described with respect to the second through fifth embodiments in FIGS. 4A, 4B, 5A, 5B and 8-11.

In the first embodiment, determining a width of the step stepped surface comprises calculating a product of a scanning speed of the incident measurement laser beam 212 across the stepped surface of the microstructure and a time between the two detected inflection points in the consecutive pair of phase inflection points. A laser emission beam from a laser may be reflected onto the stepped surface of the microstructure using a half mirror 115, which also passes the reflected laser beam 213 to a phase detector photodetector 150 to detect the consecutive pair of phase inflection points.

In the second through fifth embodiments, determining the width of the step in the stepped surface comprises detecting a consecutive pair of shifts in the detected reflected laser beam 213 intensity. Detecting the reflected laser beam from the microstructure comprises detecting the reflected laser beam using an interferometer photodetector 150.

The microstructure 200 may comprise a semiconductor device, such as vertical NAND memory device shown in FIGS. 7A-7C, and the stepped surface comprises steps in an alternating stack of insulating layers 32 and sacrificial material layers 42. The incident measurement laser beam 212 is scanned during a process of forming the stepped surface which comprises repeating steps of trimming a photoresist layer 77 shown in FIG. 2, followed by an anisotropic etch to form the next step in the stepped surface. A subsequent step of trimming the photoresist layer 77 may be adjusted based on the determined width of the step. For example, if the determined width of the step or steps is too wide (i.e., larger than a desired width)., then the next photoresist layer 77 trimming step may be decreased to trim a smaller amount of the photoresist layer 77. In contrast, if the determined width of the step or steps is too narrow (i.e., smaller than a desired width), then the next photoresist layer 77 trimming step may be increased to trim a larger amount of the photoresist layer 77.

Although the foregoing refers to particular embodiments, it will be understood that the disclosure is not so limited. It will occur to those of ordinary skill in the art that various modifications may be made to the disclosed embodiments and that such modifications are intended to be within the scope of the disclosure. Where an embodiment employing a particular structure and/or configuration is illustrated in the present disclosure, it is understood that the present disclosure may be practiced with any other compatible structures and/or configurations that are functionally equivalent provided that such substitutions are not explicitly forbidden or otherwise known to be impossible to one of ordinary skill in the art. All of the publications, patent applications and patents cited herein are incorporated herein by reference in their entirety.

1. A method of determining a width of a step in a stepped surface of a microstructure, comprising:
scanning an incident measurement laser beam across the stepped surface of the microstructure;
detecting a reflected laser beam from the microstructure; and
determining a width of the step in the stepped surface by at least one of detecting a consecutive pair of phase inflection points or consecutive pair of shifts in the detected reflected laser beam intensity.

2. The method of claim 1, wherein determining the width of the step in the stepped surface comprises detecting the consecutive pair of phase inflection points.

3. The method of claim 2, wherein determining the width of the step in the stepped surface comprises calculating a product of a scanning speed of the incident measurement laser beam across the stepped surface of the microstructure and a time between the two detected inflection points in the consecutive pair of phase inflection points.

4. The method of claim 3, further comprising reflecting a laser emission beam onto the stepped surface of the microstructure using a half mirror and passing the reflected laser beam to a phase detector photodetector to detect the consecutive pair of phase inflection points.

5. The method of claim 1, wherein determining the width of the step in the stepped surface comprises detecting a consecutive pair of shifts in the detected reflected laser beam intensity.

6. The method of claim 5, wherein detecting the reflected laser beam from the microstructure comprises detecting the reflected laser beam using an interferometer photodetector.

7. The method of claim 1, wherein the microstructure comprises a semiconductor device.

8. The method of claim 7, wherein the semiconductor device comprises a vertical NAND memory device and the stepped surface comprises steps in an alternating stack of insulating layers and sacrificial material layers.

9. The method of claim 8, wherein scanning the incident measurement laser beam occurs during a process of forming the stepped surface which comprises repeating steps of trimming a photoresist layer followed by an anisotropic etch to form a step in the stepped surface.

10. The method of claim 9, wherein a subsequent step of trimming the photoresist layer is adjusted based on the determined width of the step.

11. A laser interferometric dimension measurement tool for measurement of a dimension on a microstruture, comprising:
a stage having a top surface configured to mount an object thereupon;
an optics assembly comprising a laser beam source configured to emit a laser emission beam and a first beam splitter configured to split the laser emission beam into an incident measurement laser beam that impinges on the object and a reference laser beam that travels along a different direction than the incident measurement laser beam, wherein the incident measurement laser beam generates a reflected measurement laser beam upon reflection from the object, wherein the optics assembly is configured to direct at least a fraction of the reflected measurement laser beam and at least a fraction of the reference laser beam to a same location in a photodetector; and
a lateral actuation mechanism configured to provide relative lateral movement between the stage and the optics assembly;
wherein the photodetector is configured to detect intensity of a combined laser beam including reflected measurement laser beam and the reference laser beam, the combined laser beam having an optical interference between the reflected measurement laser beam and the reference laser beam based on optical distance variations between the reference laser beam and a combination of the incident measurement laser beam and the reflected measurement laser beam;
wherein the laser interferometric dimension measurement tool is configured to induce the optical distance variation between the reference laser beam and the combination of the incident measurement laser beam and the reflected measurement laser beam by providing a relative movement between the object and the optics assembly while the incident measurement laser beam irradiates the object, and is further configured to calculate at least one dimension representing a feature on a surface of the object, employing a computational unit including a processor and a memory unit, based on interferometric intensity modulation that is detected at the photodetector while the optical distance variation is induced.

12. The laser interferometric dimension measurement tool of claim 11, wherein the laser interferometric dimension measurement tool is configured to measure a step width of a horizontal surface located between two sidewalls and on a front surface of the object by determining a relative lateral movement distance between the optics assembly and the stage that causes a consecutive pair of shifts in a detected beam intensity at the photodetector during a relative horizontal movement between the optics assembly and the stage.

13. The laser interferometric dimension measurement tool of claim 12, wherein the laser interferometric dimension measurement tool is configured to maintain a vertical distance between the stage and the optics assembly constant while the relative horizontal movement is provided.

14. The laser interferometric dimension measurement tool of claim 11, wherein:
the first beam splitter provides the incident measurement laser beam by reflecting a first fraction of the laser emission beam off a front surface of the first beam splitter; and
the first beam splitter provides the reference laser beam by transmitting a second fraction of the laser emission beam through the first beam splitter.

15. The laser interferometric dimension measurement tool of claim 11, wherein:
the first beam splitter provides the incident measurement laser beam by transmitting a first fraction of the laser emission beam through the first beam splitter; and
the first beam splitter provides the reference laser beam by reflecting a second fraction of the laser emission beam off a front surface of the first beam splitter.

16. The laser interferometric dimension measurement tool of claim 11, wherein the optics assembly further comprises a second beam splitter configured to pass or reflect the reference laser beam to provide a first detection beam, and to reflect or pass the reflected measurement laser beam to provide a second detection beam, wherein the first detection beam and the second detection beam impinge on the photodetector.

17. The laser interferometric dimension measurement tool of claim 16, further comprising an intensity attenuator located in a path of the reference laser beam between the first beam splitter and the second beam splitter and configured to provide attenuate intensity of a portion of the reference laser beam that impinges on the second beam splitter for maximizing optical interference at the photodetector.

18. The laser interferometric dimension measurement tool of claim 11, wherein the computational unit is provided with another algorithm that calculates a difference between a pair of incremental vertical separation distances that provide respective local extrema in the detected beam intensity at two laterally separated points on the object, and to provide a step height between the two laterally separated points by calculating the difference between the pair of incremental vertical separation distances.

19-20 (canceled)

21. The method of claim 1, further comprising:
splitting a laser emission beam emitted from a laser beam source into an incident measurement laser beam and a reference laser beam;
directing a reflected measurement laser beam from the microstructure and the reference laser beam to a same location in a photodetector; and
detecting intensity of a combined laser beam including the reflected measurement laser beam and the reference laser beam at the photodetector, the combined laser beam having an optical interference between the reflected measurement laser beam and the reference laser beam based on optical distance variations between the reference laser beam and a combination of the incident measurement laser beam and the reflected measurement laser beam.

22. The method of claim 21, wherein determining the width of the step in the stepped surface is based on the detected intensity of the combined laser beam.
